(19) United States
(12) Patent Application Publication
(10) Pub. No.: US 2008/0137349 A1
(43) Pub. Date: Jun. 12, 2008

(54) COMPLEX FILM FOR DISPLAY APPARATUS AND DISPLAY APPARATUS HAVING THE SAME

(75) Inventors: Sung Nim Jo, Seoul (KR); In Sung Sohn, Suwon-si (KR); Sang Cheol Jung, Suwon-si (KR); Hye Kyoung Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Corning Co., Ltd., Suwon-si (KR)

(21) Appl. No.: 11/950,534

(22) Filed: Dec. 5, 2007

(30) Foreign Application Priority Data
Dec. 12, 2006 (KR) 10-2006-0126504

(51) Int. Cl. F21V 1/12; F21V 5/00

(52) U.S. Cl. 362/326; 362/360

(57) ABSTRACT

Disclosed is a complex film for a display apparatus, which comprises a base film; an anti-reflection film formed on a first surface of the base film and adapted to prevent reflection of external light; an external light shielding film formed on a second surface opposite to the first surface and including an external light shielding pattern, the external light shielding pattern having a plurality of external light shielding parts formed on a surface of the external light shielding film; and an adhesive film formed on the external light shielding film and including at least one colorant having a selective wavelength absorption capability. The complex film has multi-functionalities such as electromagnetic wave shielding, external light absorption, near infrared ray shielding, color correction, and the like, thereby simplifying an assembly process of the display apparatus, and reducing the thickness of the display apparatus.

### CROSS-REFERENCE TO RELATED APPLICATION

This application claims the benefit of Korean Patent Application No. 10-2006-0126504, filed on Dec. 12, 2006, in the Korean Intellectual Property Office, the entire disclosure of which is incorporated herein by reference.

### BACKGROUND OF THE INVENTION

1. Field of the Invention

The present invention relates to a complex film for a display apparatus and a display apparatus having the same, and more particularly, to a complex film for a display apparatus and a display apparatus having the same, in which functionalities such as electromagnetic wave shielding, external light absorption, near infrared ray shielding, color correction, and the like are simultaneously realized, so that a thickness of the display apparatus can be reduced when the complex film is applied to the display apparatus.

2. Description of Related Art

As modern society becomes more information oriented, technology of parts and devices related to image displays is remarkably advancing, and these parts and devices are becoming widespread. Display apparatuses utilizing parts and devices related to photoelectronics are becoming significantly widespread and used for television apparatuses, monitor apparatuses of personal computers, and the like. Also, display apparatuses are becoming both larger and thinner.

Plasma display panel (PDP) apparatuses are generally gaining popularity as next-generation display apparatuses to simultaneously satisfy a trend of becoming larger, and of becoming thinner, when compared with cathode-ray tubes (CRTs) representing existing display apparatuses. The PDP apparatuses display images using a gas discharge phenomenon, and exhibit superior display characteristics such as display resolution, brightness, contrast ratio, an afterimage, a viewing angle, and the like. Also, since the PDP apparatuses are generally seen as having the most appropriate characteristics for future high-quality digital televisions due to thin luminous display apparatuses of which enlargement is simpler than any other display apparatus, the PDP apparatuses are gaining popularity as display apparatuses and are replacing CRTs.

The PDP apparatus generates a gas discharge between electrodes by a direct current (DC) voltage or an alternating current (AC) voltage which are supplied to the electrodes. Here, ultraviolet light is generated. Then, a phosphor is excited by ultraviolet light, thereby emitting light. However, the PDP apparatus has a defect in that an amount of emitted electromagnetic (EM) radiation and near infrared (NI) radiation with respect to a driving characteristic is great, surface reflectivity of the phosphor is great, and color purity due to orange light emitted from helium (He), or xenon (Xe) used as a sealing gas is lower than the CRT. Accordingly, EM radiation and NI radiation generated in the PDP apparatus may have harmful effects on human bodies, and cause sensitive equipment such as wireless telephones, remote controls, and the like, to malfunction.

Therefore, in order to use the PDP apparatus, it is required to prevent emission of EM radiation and NI radiation emitted from the PDP apparatus from increasing to more than a predetermined level. PDP filters having functions such as an EM radiation-shielding function, an NI radiation-shielding function, a surface antiglare function, enhancement of color purity, and the like, are used for EM radiation-shielding and NI radiation-shielding while simultaneously reducing reflected light, and enhancing color purity.

Accordingly, a conventional PDP filter including films performing each function separately cannot satisfy a trend of becoming thinner in the PDP filter.

### SUMMARY OF THE INVENTION

An aspect of the present invention provides a complex film for a display apparatus which realizes multi-functionalities, thereby reducing a thickness of the display apparatus, and improving visibility and a contrast ratio in a bright room.

Another aspect of the present invention provides a display apparatus having the complex film for the display apparatus.

According to an aspect of the present invention, there is provided a complex film for a display apparatus which comprises a base film; an anti-reflection film formed on a first surface of the base film and adapted to prevent reflection of external light; an external light shielding film formed on a second surface opposite to the first surface and including an external light shielding pattern, the external light shielding pattern having a plurality of external light shielding parts formed on a surface of the external light shielding film; and an adhesive film formed on the external light shielding film and including at least one colorant having a selective wavelength absorption capability.

In this instance, each of the plurality of external light shielding parts may have a wedge form in its cross-sectional shape, and includes a conductive substance, thereby performing an electromagnetic wave shielding function.

Also, the plurality of external light shielding parts may be formed in either a stripe shape or a mesh shape.

Also, the adhesive film may include a near infrared absorbing colorant, thereby shielding near infrared rays emitted from the panel assembly.

According to another aspect of the present invention, there is provided a display apparatus which comprises a panel assembly; and a complex film for a display apparatus.

In this instance, the panel assembly includes a front substrate and a rear substrate coupled corresponding to each other, and a plurality of cells disposed between the front substrate and the rear substrate. Also, the complex film for the display apparatus comprises a base film; an anti-reflection film formed on a first surface of the base film and adapted to prevent reflection of external light; an external light shielding film formed on a second surface opposite to the first surface and including an external light shielding pattern, the external light shielding pattern having a plurality of external light shielding parts formed on a surface of the external light shielding film; and an adhesive film formed on the external light shielding film and including at least one colorant having a selective wavelength absorption capability.

The complex film for the display apparatus is coupled with the front substrate by the adhesive film.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is an exploded perspective view schematically illustrating a plasma display panel (PDP) apparatus according to an exemplary embodiment of the present invention;

FIG. 2 is a cross-sectional view illustrating a complex film for a display apparatus according to an exemplary embodiment of the present invention; and

FIG. 3 is a cross-sectional view illustrating a complex film for a display apparatus according to another exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures. In particular, a plasma display panel (hereinafter referred to as ‘PDP’) apparatus will be described in detail.

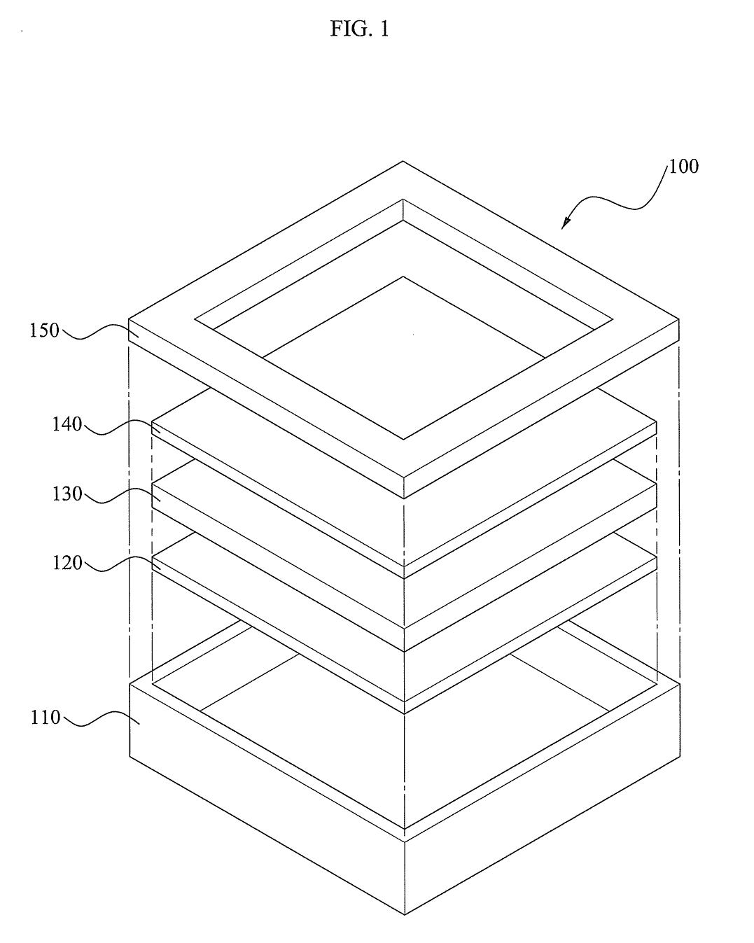

FIG. 1 is an exploded perspective view schematically illustrating a PDP apparatus 100 according to an exemplary embodiment of the present invention.

Referring to FIG. 1, the PDP apparatus 100 according to the present exemplary embodiment of the invention includes a case 110, a cover 150 for covering an upper portion of the case 110, a driving circuit board 120 received in the case 110, a panel assembly 130 including light emitting cells where a gas discharge phenomenon occurs, and a PDP filter 140. The PDP filter 140 includes a conductive film formed on a transparent substrate and made of a material having superior conductivity. The conductive layer is grounded to the case 110 via the cover 150. Specifically, an electromagnetic wave generated from the panel assembly 130 is shielded by the cover 150 and the case 110 which are grounded using the conductive layer of the PDP filter 140, before reaching a viewer.

A complex film for a display apparatus which will be described below in detail may be used as the PDP filter 140. Also, a complex film for a display apparatus according to an exemplary embodiment of the present invention may be used as one of component films of the PDP filter 140.

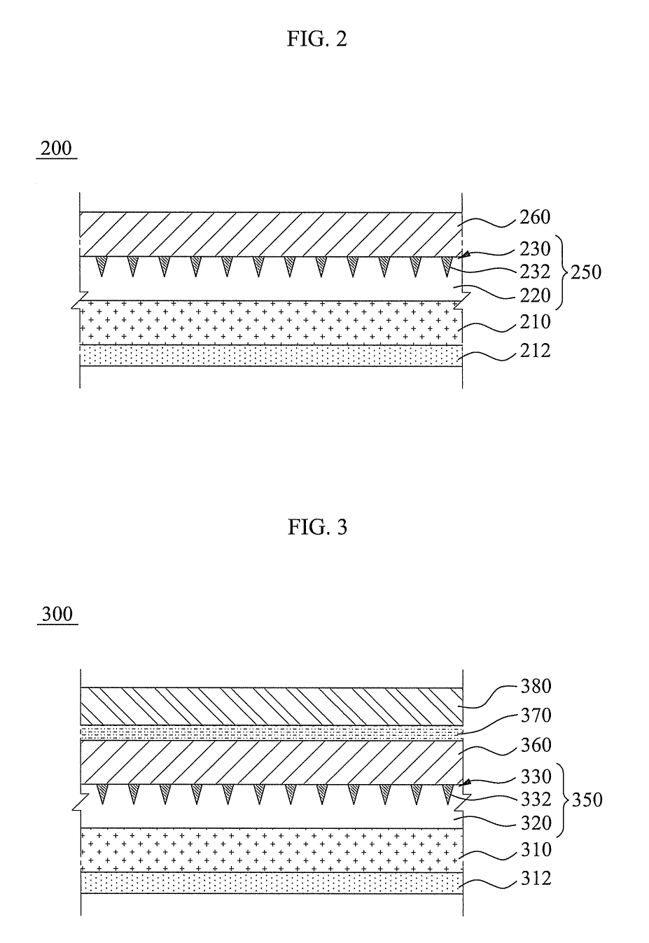

FIG. 2 is a cross-sectional view illustrating a complex film 200 for a display apparatus according to an exemplary embodiment of the present invention.

Referring to FIG. 2, the complex film 200 includes a base film 210, an anti-reflection film 212, an external light shielding film 250, and an adhesive film 260.

As examples of a transparent resin used for the base film 210, polyethylene terephthalate, acryl, polycarbonate, urethane acrylate, polyester, epoxy acrylate, brominate acrylate, and the like may be listed. Here, the transparent resin may be used alone, or in any combination of the above-mentioned transparent resins. The anti-reflection film 212 prevents light entering from the outside from being reflected. The anti-reflection film 212 may be formed of a high refractive index substance and a low refractive index substance sequentially stacked one over another.

The external light shielding film 250 includes a substrate 220, and an external light shielding pattern 230 formed on a surface of the substrate and including a plurality of external light shielding parts 232.

The substrate 220 consists of ultraviolet curable resin and the like. The external light shielding film 250 is formed such that the ultraviolet curable resin is first coated on the base film 210 and then is hardened to thereby form the substrate 220. Next, a predetermined shaped groove is formed on the substrate 220 using a heat-press method, a casting method, an injection molding method, an ultraviolet (UV) curing method and the like. Next, an inside of the groove is filled with an external light shielding substance, and the like, thereby completing the external light shielding pattern 230.

The external light shielding pattern 230 includes the plurality of external light shielding parts 232 which are spaced apart from one another by a predetermined distance and are formed in a plurality of stripe shapes. Intervals between the plurality of external light shielding parts are preferably constant.

Each of the plurality of external light shielding parts 232 according to the present exemplary embodiment of the invention has a wedge form in its cross-sectional shape, and a stripe form when view from the top. Accordingly, the external light shielding pattern 230 has a linear pattern composed of a plurality of stripes.

Each of the plurality of external light shielding parts 232 includes an external light absorbing substance such as a carbon black and a conductive substance, thereby having an electromagnetic wave shielding functionality. Specifically, the external light shielding film 250 functions to improve a contrast ratio in a bright room due to the external light absorption, and effectively block an electromagnetic wave.

The external light shielding part 232 may be formed on any surface of the substrate 220. However, the external light shielding part 232 according to the present exemplary embodiment of the invention is formed on a surface of the substrate 220 which abuts against the adhesive film 260.

The conductive substance may include a conductive polymer.

As examples of the conductive polymer, polythiophene, polypyrrole, polyaniline, poly(3,4-ethylenedioxythiophene), poly(3-alkylthiophene), polyisothianaphthene, poly(p-phenylenevinylene), poly(p-phenylene), and a derivative thereof may be listed. In this instance, the conductive polymer may be used alone, or in any combination of the above-mentioned resins.

As examples of the conductive substance, a carbon nanotube, a copper oxide, an indium tin oxide (ITO), and the like, may be listed.

The external light shielding pattern 230 may be formed in a mesh shape in order to improve an electromagnetic wave shielding effectiveness. Specifically, the external light shielding pattern 230 includes a plurality of external light shielding parts 232 orthogonal to each other.

The adhesive film 260 includes an adhesive resin and at least one colorant having a selective wavelength absorption capability. Here, the at least one colorant performs functionality such as near infrared ray shielding, color correction, and the like.

Acrylic-based resin may be used as the adhesive resin, however, the present invention is not limited thereto. Also, the adhesive film 260 preferably contains about 0.1 to 20 parts by weight of the colorant based on 100 parts by weight of a solid content of the adhesive resin.

In particular, as examples of the colorants used for near infrared ray absorption, cobalt-based colorants, iron-based colorants, chromium-based colorants, titanium-based colorants, diimmonium-based colorants, anthraquinone-based colorants, aminium-based colorants, polymethine-based colorants, azo-based colorants, and dithiol-based metal complex colorants may be listed. In this instance, the colorant may be used alone or in any combination of the above-mentioned colorants.

Also, the adhesive film 260 may further include a colorant capable of absorbing an orange color-based wavelength.

FIG. 3 is a cross-sectional view illustrating a complex film for a display apparatus according to another exemplary embodiment of the present invention. As illustrated in FIG. 3, a complex film 300 for a display apparatus has the same components as those of the complex film for the display apparatus of FIG. 2 except for a conductive film 370 and a transparent substrate 380 as compared with the complex film of FIG. 2, and thus, repetitive explanations will be omitted.

Referring to FIG. 3, the complex film 300 includes a base film 310, an anti-reflection film 312, an external light shielding film 350, an adhesive film 360, the conductive film 370, and the transparent substrate 380.

The complex film 300 according to the present exemplary embodiment of the invention performs independently, acting as a separate filter. Conversely, the complex filter 200 of FIG. 2 may perform dependently, such as being directly adhered to the panel assembly or coupled with another functional film.

The external light shielding film 350 includes a substrate 320, and an external light shielding pattern 330 formed on a surface of the substrate 320 and including a plurality of external light shielding parts 332.

The conductive film 370 may complement the electromagnetic wave shielding performance acquired by the external light shielding film 350.

The conductive film 370 may include a conductive metal pattern. The conductive metal pattern may perform a similar function to that of a mesh type electromagnetic wave shielding film. Unlike this, the conductive film 370 may consist of a metal oxide film including a metal oxide such as an indium tin oxide (ITO) and the like.

The transparent substrate 380 functions to protect the complex film 300, and allows the complex film 300 to be used as an independent component.

A material such as a glass and the like may be used for the transparent substrate 380.

The complex films 200 and 300 for the display apparatus as described in FIGS. 2 and 3 may be applied to a display apparatus such as a PDP and the like.

In particular, the complex film 200 for the display apparatus of FIG. 2 may be coupled with a surface of the panel assembly (not shown) through the intermediary of the adhesive film 260.

The complex film 300 for the display apparatus of FIG. 3 may be independently used as a separate filter. Specifically, the complex film 300 may be spaced apart from a surface of the panel assembly (not shown), or separately disposed.

In particular, when the complex films 200 and 300 are applied to a PDP display apparatus, the external light shielding parts 232 and 332 respectively formed on the external light shielding films 250 and 350 are preferably formed on each surface of the substrates 220 and 320 in such a manner as to face the panel assembly.

As described above, according to the present invention, the complex film for the display apparatus may be applied to a display apparatus such as a PDP and the like, thereby realizing multi-functionalities such as electromagnetic wave shielding, external light shielding, near infrared ray shielding, anti-reflection, color correction, and the like.

Accordingly, the complex film may be applied to a display apparatus, thereby simplifying a manufacturing process of the display apparatus, and reducing the thickness of the display apparatus.

Also, the complex film may include the external light shielding film, thereby improving a contrast ratio in a bright room, and maximizing display quality of the display apparatus.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A complex film for a display apparatus, comprising:
a base film;
an anti-reflection film formed on a first surface of the base film and adapted to prevent reflection of external light;
an external light shielding film formed on a second surface opposite to the first surface and including an external light shielding pattern, the external light shielding pattern having a plurality of external light shielding parts formed on a surface of the external light shielding film; and
an adhesive film formed on the external light shielding film and including at least one colorant having a selective wavelength absorption capability.

2. The complex film of claim 1, wherein the base film includes a polyethylene terephthalate (PET) resin.

3. The complex film of claim 1, wherein the anti-reflection film is configured such that a high refractive index substance and a low refractive index substance are sequentially repeated.

4. The complex film of claim 1, wherein the plurality of external light shielding parts are formed on a surface of the external light shielding film facing the adhesive film.

5. The complex film of claim 1, wherein each of the plurality of external light shielding parts has a wedge form in its cross-sectional shape, and includes a conductive substance.

6. The complex film of claim 5, wherein the conductive substance includes a conductive polymer.

7. The complex film of claim 6, wherein the conductive polymer includes at least one polymer selected from the group consisting of polythiophene, polypyrrole, polyaniline, poly(3,4-ethylenedioxythiophene), poly(3-alkylthiophene), polyisothianaphthene, poly(p-phenylenevinylene), poly(p-phenylene), and a derivative thereof.

8. The complex film of claim 6, wherein the conductive polymer includes at least one substance selected from the group consisting of a carbon nanotube, a copper oxide, and an indium tin oxide (ITO).

9. The complex film of claim 1, wherein each of the plurality of external light shielding parts is spaced apart from one another by a predetermined distance and has a stripe shape.

10. The complex film of claim 1, wherein the external light shielding pattern includes a plurality of external light shielding parts orthogonal to each other, and has a mesh shape.

11. The complex film of claim 1, wherein the adhesive film includes a near infrared absorbing colorant.

12. The complex film of claim 11, wherein the near infrared absorbing colorant includes at least one colorant selected from the group consisting of cobalt-based colorants, iron-based colorants, chromium-based colorants, titanium-based colorants, diimmonium-based colorants, anthraquinone-based colorants, aminium-based colorants, polymethine-based colorants, azo-based colorants, and dithiol-based metal complex colorants.

13. The complex film of claim 1, further comprising:
a conductive film formed on the adhesive film; and
a transparent substrate formed on the conductive film.

14. The complex film of claim 13, wherein the conductive film includes a conductive metal pattern.

15. The complex film of claim 13, wherein the conductive film includes a metal oxide.

16. The complex film of claim 13, wherein the transparent substrate is a glass.

17. A display apparatus, comprising:
a panel assembly including a front substrate and a rear substrate coupled corresponding to each other, and a plurality of cells disposed between the front substrate and the rear substrate; and
a complex film for a display apparatus disposed on the front substrate, the complex film comprising:
a base film;
an anti-reflection film formed on a first surface of the base film and adapted to prevent reflection of external light;
an external light shielding film formed on a second surface opposite to the first surface and including an external light shielding pattern, the external light shielding pattern having a plurality of external light shielding parts formed on a surface of the external light shielding film; and
an adhesive film formed on the external light shielding film and including at least one colorant having a selective wavelength absorption capability.

18. The display apparatus of claim 17, wherein the complex film is coupled with the front substrate by the adhesive film.

19. The display apparatus of claim 18, wherein the external light shielding pattern is formed on a surface of the external light shielding film in such a manner as to face the panel assembly.
